(19) United States
(12) Patent Application Publication
(10) Pub. No.: US 2009/0108046 A1
(43) Pub. Date: Apr. 30, 2009

(54) Trigger Switch Mechanism for Nail Gun

(76) Inventor: Chi-Sheng Huang, Taipei Hsien (TW)

Correspondence Address: HDLS Patent & Trademark Services, P.O. BOX 220746, CHANTILLY, VA, 20153-0746, US

(21) Appl. No.: 11/877,711

(22) Filed: Oct. 24, 2007

(51) Int. Cl. B27F 7/30

(52) U.S. Cl. 227/8

(57) ABSTRACT

A trigger switch mechanism for a nail gun includes a trigger valve formed on the nail gun for trigger nail shooting, a safety slidable rod configured to push against a workpiece and indirectly drive the trigger valve, a main trigger arranged between the safety slidable rod and the trigger valve, and an inner trigger disposed in the main trigger for touching the trigger valve to switch on the trigger valve. The main trigger drives the inner trigger to extend to or to leave a touchable position of the safety slidable rod, and thereby the nail gun performs in a sequential actuation mode. An outer trigger is arranged on an outer side of the main trigger for driving the inner trigger to hold the inner trigger at a position where the safety slidable rod can touch the inner trigger, and thereby the nail gun performs in a contact actuation mode.

### BACKGROUND

The present invention relates to a trigger switch mechanism for a nail gun, and more particularly to a trigger switch mechanism which includes a main trigger and an outer trigger disposed outside the main trigger to control movement of an inner trigger, thereby switching the nail gun operation in a sequential actuation mode, or a contact actuation mode.

A pneumatic nail gun is a type of tool used to drive nails into wood or some other kind of material by a hitting rod which is driven by compressed air. Movement of the hitting rod is cooperatively controlled by a safety slidable rod, a trigger valve, a main trigger, and an inner trigger disposed on a gun body.

Actuating nails for a pneumatic nail gun can generally be divided into two kinds, one is the sequential actuation mode (or the restrictive mode) and the other is the contact actuation mode.

In the sequential actuation mode, an operator should first set a safety slidable rod or a hitting base on the safety slidable rod pressing on a workpiece to push an upward movement of an inner trigger, and then press a main trigger to bring the inner trigger to actuate a trigger valve. In this mode, if the operator wants to actuate again, he/she should release the main trigger first, and then repeat the processes of pressing the main trigger when the safety slidable rod or the hitting base on the safety slidable rod presses on a workpiece again.

In the contact actuation mode, the operator should first continuously press the main trigger, and then move the safety slidable rod or the hitting base of the safety slidable rod on the workpiece to perform continuously contact hitting, which makes the inner trigger brought to upwardly move and actuates the trigger valve to continuous shot. However, if the operator inadvertently presses the main trigger and erroneously touches the safety slidable rod or the hitting base, accidentally dangerous shot easily happens.

In order to avoid the above-mentioned danger, in a known technology, these two actuation modes are both used in a nail gun by utilizing a switch mechanism to realize switching of the sequential actuation mode and the contact actuation mode. As shown in U.S. Pub. No. 20050184120, a rotating rod is included in a contact safety assembly which is constructed to slide toward/away from a driver housing. The rotating rod includes a first shoulder or ledge and a second shoulder which is off-set from the first shoulder. The rod may be rotated via a switch button thereon in order to orientate the selected shoulder, to function as a step for a pivoting trigger assembly, which is constructed to contact a pneumatic valve, to initiate a fastening event in which a fastener is driven into a workpiece. The configuration of the rotating rod permits for selection between a contact actuation mode and a sequential actuation mode. However, when the sequential actuation mode is selected, if an operator first pulls the main trigger, and then arranges the safety slidable rod or the hitting base to press on a workpiece, thus, the trigger lever may not be driven by the rotating rod which is driven by the safety slidable rod, thereby not switching on the trigger valve. Thus, an operation for hitting a nail can not be performed.

However, the above-mentioned switch button is longitudinally rotated relative to a hitting nail direction, and yet, the main trigger is traversely pulled. Therefore, it is inconvenient for the operator to operate the switch button and the main trigger by a finger of a hand, and the switch button is driven by the other hand. Thus, in operation, it is a disadvantage to select the sequential actuation mode and the contact actuation mode using a single hand. Accordingly, the above-mentioned mechanism need to be further improved.

### BRIEF SUMMARY

What is needed, therefore, is to provide a trigger switch mechanism for a nail gun, which a main trigger of the switch mechanism is pulled to selectively switch the sequential actuation mode and the contact actuation mode.

An object and effect of the present invention is carried out through the following technology means. A switch mechanism for a nail gun includes a trigger valve formed on the nail gun; a safety slidable rod configured to push against a workpiece and indirectly drive the trigger valve; a main trigger arranged between the safety slidable rod and the trigger valve; an outer trigger arranged on an outer side of the main trigger; and an inner trigger disposed in the main trigger for touching the trigger valve to switch on, wherein the main trigger drives the inner trigger to move upwards or away from a touchable position for the safety slidable rod, thereby performing a sequential actuation mode; wherein the outer trigger can drive the inner trigger to make the inner trigger hold in a position where the safety slidable rod can touch the inner trigger, thereby performing a contact actuation mode. Hereby, it is very convenient to selectively switch the sequential actuation mode and the contact actuation mode when the main trigger is pressed or released.

In addition, the present invention further includes a first elastic member disposed between the trigger valve and the main trigger or inner trigger for driving the inner trigger to lift up or be away from a touchable position for the safety slidable rod. An adjusting base is pivotally mounted on the main trigger, the inner trigger is pivotally mounted on the adjusting base, and the outer trigger can drive the adjusting base to swing, thereby driving the inner trigger to hold in a touchable position for the safety slidable rod. A pull rod is connected to the outer trigger and the adjusting base for driving the adjusting base to swing. The adjusting base is formed to have an ear portion extending out from the main trigger, and the outer trigger is formed to have a protrusion thereon for driving the ear portion to cause swing of the adjusting base. The main trigger defines a through hole therein for receiving the ear portion and the protrusion. A supporting rod is pivotally disposed on the main trigger for driving or releasing the adjusting base to swing. A first stop block is formed on the main trigger for stopping the supporting rod in a position where the adjusting base is released to swing, and a second stop block is formed on the main trigger for stopping the supporting rod in a position where the adjusting base is driven to swing. A first press surface is formed on the main trigger for conveniently being pressed by a finger, and a push surface is formed on the outer trigger for keeping close to the first press surface when pulling the outer trigger. The outer trigger is pivotally mounted on an outer surface of the main trigger. A second press surface is formed on the outer trigger for conveniently being pressed by a finger. A second elastic member is disposed on the outer trigger for driving the outer trigger to return to an original position, thereby releasing the inner trigger to return to an original position.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, partially cross-sectional view of a trigger mechanism for a nail gun in accordance with a first preferred embodiment of the present invention;

FIG. 2 is a partially enlarged view of FIG. 1;

FIG. 3 is an exploded view of the trigger mechanism for the nail gun in accordance with the first preferred embodiment of the present invention;

FIG. 4 is a schematic view of the first preferred embodiment of the present invention in a use status;

FIG. 5 is another schematic view of FIG. 4 in a use status;

FIG. 6 is another schematic view of the first preferred embodiment of the present invention in a use status;

FIG. 7 is another schematic view of FIG. 6 in a use status;

FIG. 8 is a third schematic view of FIG. 6 in a use status;

FIG. 9 is a fourth schematic view of FIG. 6 in a use status;

FIG. 10 is a cross-sectional view of a trigger mechanism for a nail gun in accordance with a second preferred embodiment of the present invention;

FIG. 11 is a schematic view of FIG. 10 in a use status.

### DETAILED DESCRIPTION

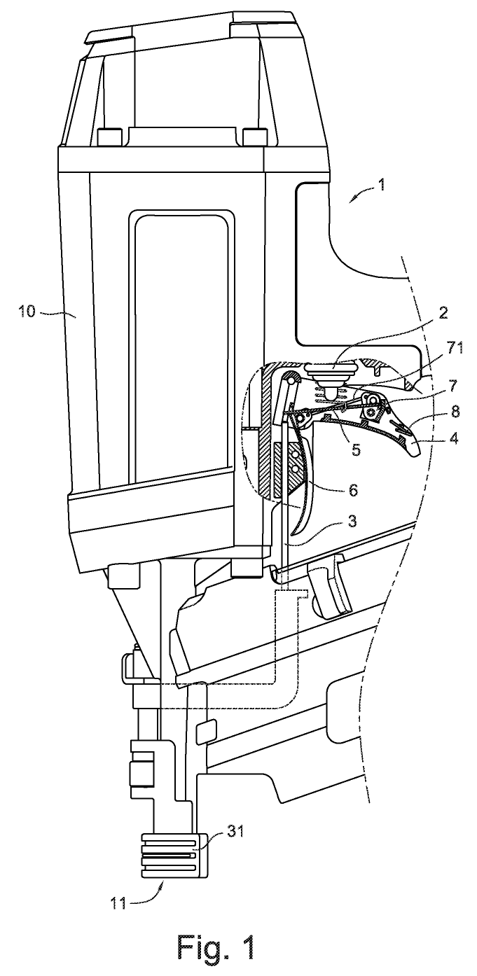

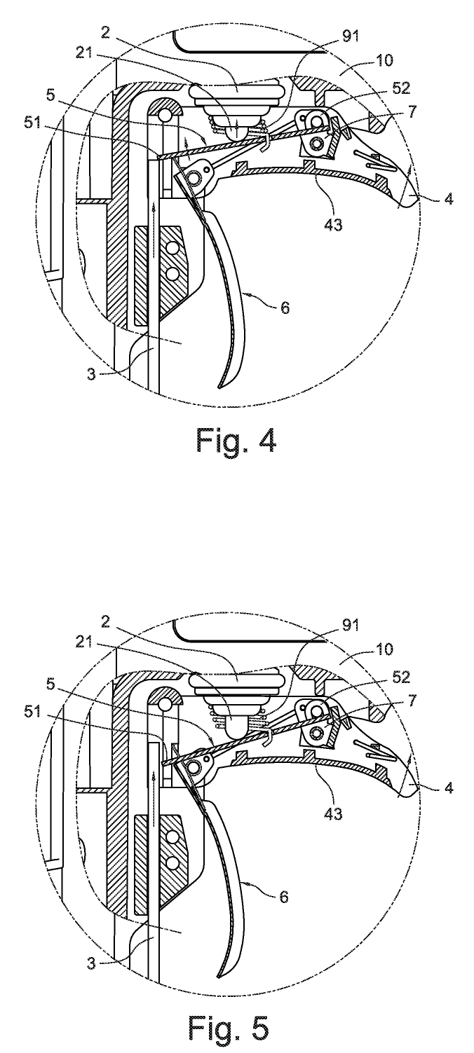

Referring to FIGS. 1 to 3, a trigger switch mechanism for a nail gun in accordance with an exemplary embodiment of the present invention is shown. A trigger valve 2 which is configured for driving to hit a nail, is formed in a housing 10 of a nail gun 1. A safety slidable rod 3 is configured to push against a workpiece and indirectly drive the trigger valve 2. A main trigger 4 is pivotally arranged in the housing 10 and located between the trigger valve 2 and the safety slidable rod 3. An inner trigger 5 is pivotally disposed in the main trigger 4 to touch the trigger valve 2 to switch on. The main trigger can drive the inner trigger to lift up or disengage from the safety slidable rod 3 to a touchable position for the safety slidable rod 3 (referring to FIGS. 4 and 5).

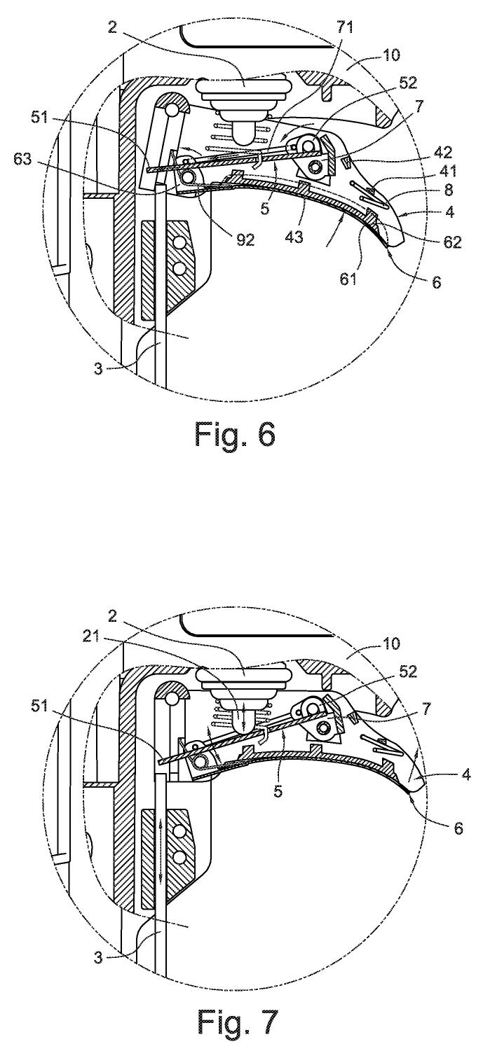

According to the above-mentioned, an outer trigger 6 is pivotally mounted on the housing 10 outside the main trigger 4 or an outer side surface of the main trigger 4 via a first shaft 60 thereon, as illustrated in FIGS. 1 to 3. The outer trigger 6 can drive the inner trigger 5 to make the inner trigger 5 hold in a position where the safety slidable rod 3 can touch the inner trigger 5, as illustrated in FIGS. 6 to 8. In greater detail, the exemplary embodiment of the present invention includes:

A valve rod 21 is formed on the trigger valve 2 for switching on the trigger valve 2. The valve rod 21, opposing the inner trigger 5, is extended into the main trigger 4.

The safety slidable rod 3 is bent shaped. An end of the safety slidable rod 3 extends into the main trigger 4 to drive the inner trigger 5, and the other end of the safety slidable rod 3 connects with the hitting base 31 and extends out of a hitting mouth 11 of the housing 10.

A first elastic member 91 is arranged between the trigger valve 2 and the main trigger 4 or the inner trigger 5. In the exemplary embodiment, the first elastic member 91 may be a compression spring or the like. An end of the compression spring is displaced around the valve rod 21, and the opposite end of the compression spring extends into a through hole 53 defined in the inner trigger 5 to thereby securely attaching to the inner trigger 5. The first elastic member 91 can drive the main trigger 4 to swing, thereby causing the inner trigger 5 to lift up or disengage from the safety slidable rod 3 to a touchable position for the safety slidable rod 3 (referring to FIGS. 4 and 5).

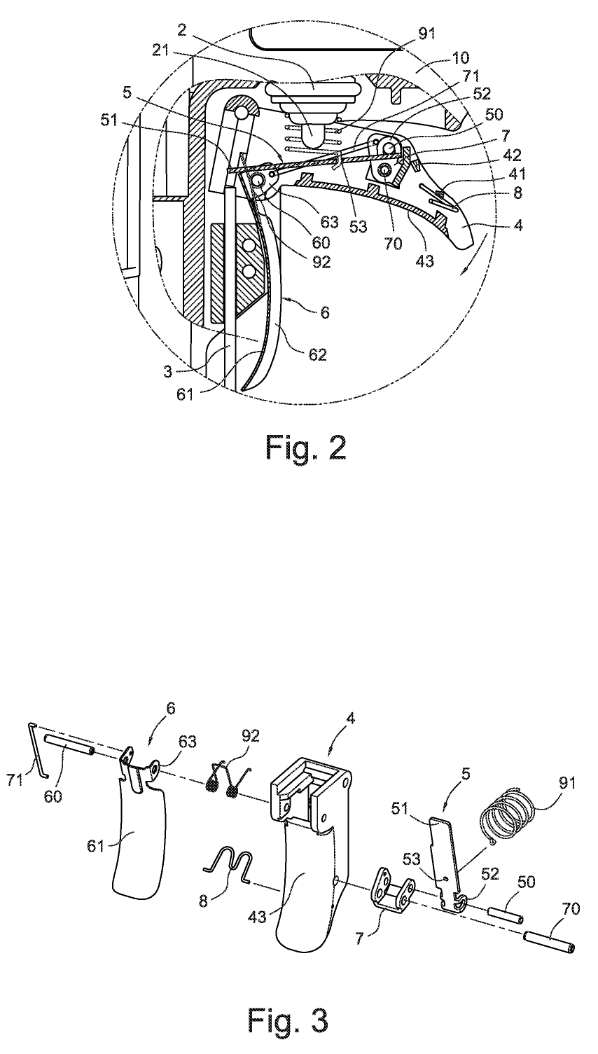

As illustrated in FIGS. 2 and 3, an end of the inner trigger 5 is formed to have a tongue portion 51 thereon, and an opposite end of the inner trigger 5 is formed to have a pivotal portion 52 thereon. When the tongue portion 51 and the pivotal portion 52 of the inner trigger 5 are lift up, a central portion of the inner trigger 5 resist against the valve rod 21 of the trigger valve 2.

An adjusting base 7 is pivotally mounted on the main trigger 4 via a second shaft connected with the main trigger 4. The pivotal portion 52 of the inner trigger 5 is rotatably fixed to the adjusting base 7 via a third shaft 50, biased against the second shaft 70.

An end of the outer trigger 6 is formed to have a shaft mounting portion 63 thereon. The shaft mounting portion 63 of the outer trigger 6 is pivotally mounted on an outer side surface of the main trigger 4. Two opposite ends of a pull rod 71 is respectively connected to the shaft mounting portion 63 and the adjusting base 7, biased against and the first shaft 60 and the second shaft 70. The outer trigger 6 can drive the adjusting base 7 to swing via the pull rod 71, thereby driving the inner trigger 5 to hold in the touchable position for the safety slidable rod 3.

As illustrated in FIGS. 2 and 3, the main trigger 4 is formed to have an arc-shaped first press surface 43 thereon for being conveniently pressed by fingers, and the outer trigger 6 is formed to have an arc-shaped second press surface 61 thereon for being conveniently pressed by fingers. The outer trigger 6 is formed to have an arc-shaped push surface 62 thereon, opposing the first press surface 43. When the outer trigger 6 is pulled, the push surface 62 can keep close to the first press surface 43 (as shown in FIG. 6).

A second elastic member 92 is disposed on the outer trigger 6 (referring to FIGS. 2 and 3). In the exemplary embodiment, the second elastic member 92 may be a torsion spring or the like. The torsion spring is displaced around the first shaft 60, an end of the torsion spring is attached to the main trigger 4, and the opposite end of the torsion spring is attached to the outer trigger 6. The second elastic member 92 can drive the outer trigger 6 to return to an original position without interfering in pressing the main trigger 4 by finger, thereby releasing the inner trigger 5 to return to an original position.

According to the aforementioned structure, the sequential actuation mode (or the restrictive mode) and the contact actuation mode of the exemplary embodiment is described as follows.

(1) Sequential actuation mode: before the operator presses the main trigger 4, the first elastic member 91 can drive the main trigger 4 to swing towards the hitting mouth 11, thereby driving the tongue portion 51 of the inner trigger 5 to lift up to a touchable position for the safety slidable rod 3. The sequential actuation mode may be thus performed. At this moment, the operator must push the hitting base 31 at the bottom portion of the safety slidable rod 3 on a workpiece, which makes the hitting base 31 and the safety slidable rod 3 to move upwardly (as shown in FIG. 4), and bring the tongue portion 51 of the inner trigger 5 to move upward. After that, the operator can press against the first press surface 43 of the main trigger 4 to bring an upward movement of the main trigger 4, which drives the pivotal portion 52 of the inner trigger 5 to move upwardly to push the valve rod 21 of the trigger valve 2, and actuate the nail gun 1 to sequentially shoot nails.

In addition, if the operator operates the nail gun 1 incorrectly, i.e. the operator first presses the main trigger 4 (as shown in FIG. 5), and then pushes the hitting base 31 or the safety slidable rod 3 to bring the safety slidable rod 3 to upwardly move, no actuating event happens, because before the main trigger 4 is pressed, the inner trigger 5 is driven by the adjusting base 7 to cause the tongue portion 51 of the inner trigger 5 away from a position where the safety slidable rod 3 can reach. Thus, the valve rod 21 of the trigger valve 2 can not be actuated. Therefore, a safe sequential actuation mode is realized.

(2) Contact actuation mode. Referring to FIG. 6, the operator can pull the outer trigger 6 by pressing a second press surface 61 with a finger of a hand holding the nail gun 1. Upon pulling, the outer trigger 6 can overcome the elastic force exerted by the second elastic member 92 and swing toward the trigger valve 2. Consequently, an shaft mounting portion 63 of the outer trigger 6 turns around and drives the adjusting base 7 to move by the pull rod 71 so as to drive the tongue portion 51 of the inner trigger 5 to extend further toward a contact position of the safety slidable rod 3 and to further keep the tongue portion 51 at the contact position of the safety slidable rod 3. In the meanwhile, the push surface 62 of the outer trigger 6 touches a first press surface 43 of the main trigger 4. By this means, the operator can hit nails in contact actuation mode. Referring to FIG. 7, the operator can press the outer trigger 6 continuously, which pushes the main trigger 4 to be touching with the gun body 10, drive the pivotal portion 52 of the inner trigger by the main trigger 4 and the adjusting base 7 to move upward and then push the hitting base 31 of the safety slidable rod 3 onto a workpiece. The hitting base 31 can drive the safety slidable rod 3 to move upward, which in turn drives the tongue portion 51 of the inner trigger 5 to move upward so as to drive the whole inner trigger 5 upward to push the valve rod 21 of the trigger valve 2 and drive the hitting rod inside the nail gun 1 to hit nails. In this mode, the operator can press and hold the outer trigger 6 while repeatedly releasing and pushing the hitting base 31 on the workpiece so as to continuously operate the tongue portion 51 of the inner trigger 5 by the safety slidable rod 3 and thus continuously hitting nails in contact actuation mode.

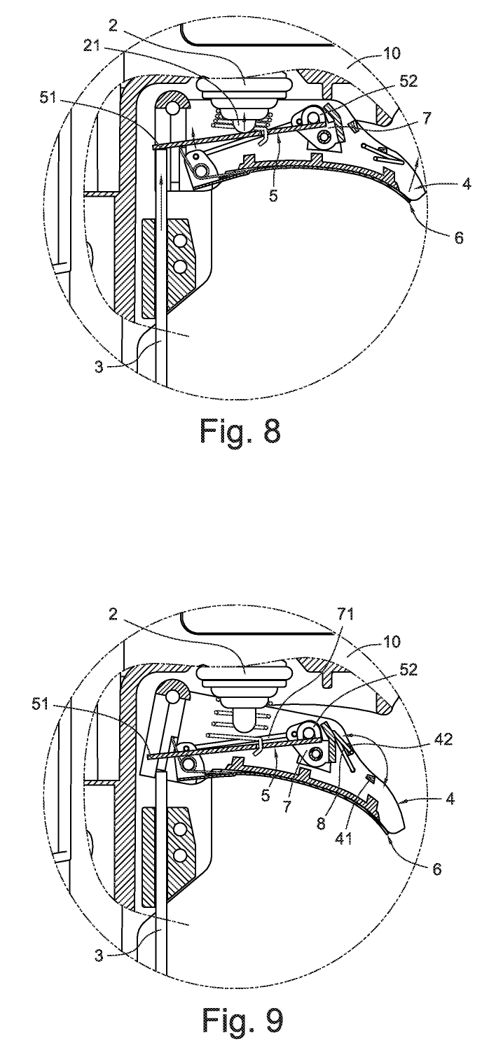

In contact actuation mode, referring to FIG. 8, when the outer trigger 6 swings to the push surface 62 and touches the first press surface 43, the operator can also push the hitting base 31 onto the workpiece, which drives the safety slidable rod 3 to move upward to support the tongue portion 51 of the inner trigger 5 to move upward. The operator can continue to pull the outer trigger 6 to push the main trigger 4 to touch the gun body 10 as illustrated in FIG. 8. The pivotal portion 52 of the inner trigger 5 is driven by the main trigger 4 and the adjusting base 7 to move upward which in turn drives the whole inner trigger 5 upward to push the valve rod 21 of the trigger valve 2 and thereby drives the hitting rod in the nail gun 1 to hit nails. By this means, one or multiple nails can be nailed on the workpiece by pull the outer trigger 6 one or multiple times.

When intending to switch the nail gun 1 from contact actuation mode to sequential actuation mode, the operator can release the outer trigger 6 so that the second elastic member 92 drives the outer trigger to swing toward the hitting mouth 11 to recover its position, referring to FIG. 2. The outer trigger drives the adjusting base 7 by the pull rod 71 to further drive the inner trigger 5 to recover its position. By this means, the nail gun 1 is switched to sequential actuation mode.

In this embodiment, the outer trigger can swing toward an axial direction of the nailing gun 1 and it is easy for the operator to use the finger that he uses to pull the main trigger 4 to pull or release the outer trigger 6 so that the convenience of switching the nail gun 1 between sequential actuation mode and contact actuation mode is improved. In addition, in above situations, the valve rod 21 of the trigger valve 2 can not be touched by mistake to shoot nails, which enhanced the safety of disposing, carrying or using the nail gun 1.

Referring to FIG. 1 to FIG. 3, an “M” shaped supporting rod 8 can be pivotally disposed in the main trigger 4, which can be used to brake or release the adjusting base 7, as shown in FIG. 9. Referring to FIG. 2, at lease a first stop block 41 and at least a second stop block 42 are disposed in the main trigger 4. In this embodiment, two corresponding first stop blocks 41 and two corresponding second stop blocks 42 are respectively disposed on inner sidewalls of two ends of the main trigger 4. The first stop blocks 41 can stop the supporting rod 8 at a position to release the adjusting base 7 to swing. The second stop blocks can stop the supporting rod 8 at a position to brake the swinging adjusting base 7 (as shown in FIG. 9). When the operator switches the nail gun 1 to contact actuation mode, referring to FIG. 6, the operator can move the supporting rod 8 to overcome the interference from the first stop blocks 41 so that the supporting rod 8 can swing to a position to brake the adjusting base 7, as illustrated in FIG. 9. In other words, the supporting 8 pushes an end of the adjusting base 7 and the second stop blocks 42 prevent the supporting rod 8 from swinging so as to brake the swinging adjusting base 7 and helps the outer trigger 6 to be positioned on the main trigger 4. The operator can hence keep the nail gun 1 in contact actuation mode without pulling the outer trigger 6. When the operator intends to release the outer trigger 6, he can move the supporting rod 8 again to overcome the interference from the second stop blocks 42 and release the supporting rod 8 from a side of the adjusting base 7 so as to reset the adjusting base 7, the inner trigger 5 and the outer trigger 6, as shown in FIG. 2, and to move the supporting rod 8 to a position where it can be supported by the first stop blocks 41.

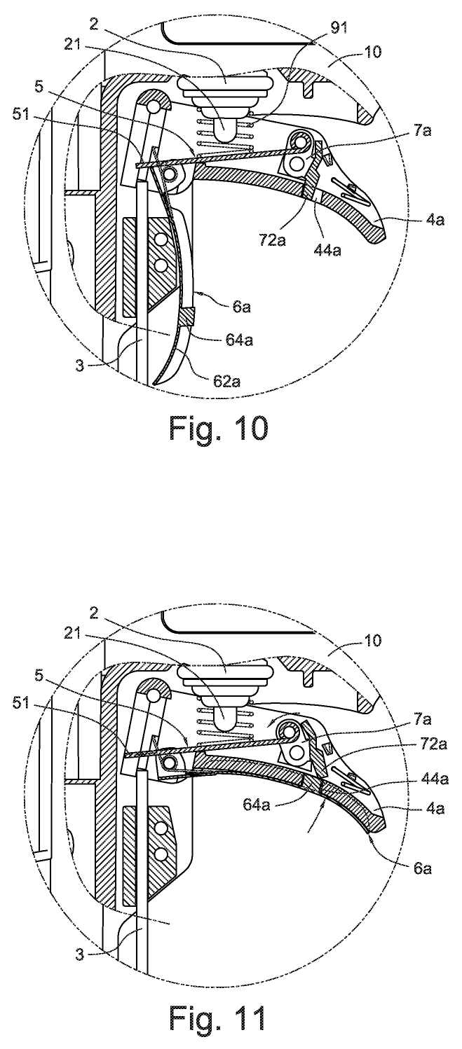

Referring to FIG. 10, which is a cross-sectional view of a second embodiment of the present invention. In this embodiment, an ear portion 72a can be formed on the adjusting base 7a and naked on the main trigger 4a. A protruding portion 64a can be formed on the push surface 62a of the outer trigger 62a. The adjusting base 7a can be driven to swing by driving the ear portion 72a to move (as shown in FIG. 11). A though hole 44a is disposed on the main trigger 4a for implanting the ear portion 72a and the protruding portion 64a therein. The rest composition of this embodiment is equivalent to the first embodiment of the present invention.

In this embodiment, when the outer trigger 6a is not pulled by the operator, as shown in FIG. 10, the inner trigger 5 is driven by the first elastic member 91 to rotate the adjusting base 7a so as to implant the ear portion 72a into the through hole 44a of the main trigger 4a and thus drive the adjusting base 7a to drive the tongue portion 5 of the inner trigger 5 to extend to a position touchable by the safety slidable rod 3. This way, the nail gun 1 is set in sequential actuation mode. When the operator pulls the outer trigger 6a, referring to FIG. 11, the outer trigger 6a moves toward the valve rod 21 of the trigger valve 2 so as to implant the protruding portion 64a into the through hole 44a of the main trigger 4a and push the ear portion 72a to move and drive the adjusting base 7a to swing. The adjusting base 7a thus drives the tongue portion 51 of the inner trigger 5 to further extend toward the touchable position of the safety slidable rod 3 and keeps the tongue portion 51 at the touchable position of the safety slidable rod 3. This way, the nail gun 1 is set in contact actuation mode. The rest operation of this embodiment is equivalent to the first embodiment of the present invention.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A trigger switch mechanism for a nail gun, the nail gun having a trigger valve formed thereon and a safety slidable rod being configured to push against a workpiece and indirectly drive the trigger valve, the trigger switch mechanism comprising:
a main trigger arranged between the safety slidable rod and the trigger valve;
an outer trigger arranged on an outer side of the main trigger; and
an inner trigger disposed in the main trigger for touching the trigger valve to switch on the trigger valve, wherein the main trigger drives the inner trigger to extend to or to leave a touchable position of the safety slidable rod, and thereby the nail gun performs in a sequential actuation mode;
wherein the outer trigger can drive the inner trigger to hold the inner trigger at a position where the safety slidable rod can touch the inner trigger, and thereby the nail gun performs in a contact actuation mode.

2. The trigger switch mechanism as described in claim 1, further comprising a first elastic member disposed between the trigger valve and the main trigger or inner trigger for driving the inner trigger to lift up or be away from a touchable position for the safety slidable rod.

3. The trigger switch mechanism as described in claim 1, wherein an adjusting base is pivotally mounted on the main trigger, the inner trigger is pivotally mounted on the adjusting base, and the outer trigger can drive the adjusting base to swing, thereby driving the inner trigger to hold in a touchable position for the safety slidable rod.

4. The trigger switch mechanism as described in claim 3, wherein a pull rod is connected to the outer trigger and the adjusting base for driving the adjusting base to swing.

5. The trigger switch mechanism as described in claim 3, wherein the adjusting base is formed to have an ear portion extending out from the main trigger, and the outer trigger is formed to have a protrusion thereon for driving the ear portion to cause swing of the adjusting base.

6. The trigger switch mechanism as described in claim 5, wherein the main trigger defines a through hole therein for receiving the ear portion and the protrusion.

7. The trigger switch mechanism as described in claim 3, wherein a supporting rod is pivotally disposed on the main trigger for driving or releasing the adjusting base to swing.

8. The trigger switch mechanism as described in claim 7, wherein a first stop block is formed on the main trigger for stopping the supporting rod in a position where the adjusting base is released to swing, and a second stop block is formed on the main trigger for stopping the supporting rod in a position where the adjusting base is driven to swing.

9. The trigger switch mechanism as described in claim 1, wherein a first press surface is formed on the main trigger for conveniently being pressed by a finger, and a push surface is formed on the outer trigger for keeping close to the first press surface when pulling the outer trigger.

10. The trigger switch mechanism as described in claim 1, wherein the outer trigger is pivotally mounted on an outer surface of the main trigger.

11. The trigger switch mechanism as described in claim 1, wherein a second press surface is formed on the outer trigger for conveniently being pressed by a finger.

12. The trigger switch mechanism as described in claim 1, wherein a second elastic member is disposed on the outer trigger for driving the outer trigger to return to an original position, thereby releasing the inner trigger to return to an original position.
